(19) United States
(12) Patent Application Publication
(10) Pub. No.: US 2011/0244354 A1
(43) Pub. Date: Oct. 6, 2011

(54) Fuel Cell System and Method for Production Thereof

(76) Inventors: Ines Becker, Nurnberg (DE); Erich Bittner, Ellingen (DE); James E. Gillett, Greensburg, PA (US); Wilhelm Kleinlein, Furth (DE); Paolo R. Zafred, Murrysville, PA (US)

(21) Appl. No.: 12/680,306

(22) PCT Filed: Sep. 26, 2008
(86) PCT No.: PCT/EP2008/062928

§ 371 Date: Jun. 21, 2011

(30) Foreign Application Priority Data
Sep. 28, 2007 (DE) 10 2007 046 977.4

(51) Int. Cl. H01M 8/12; H01M 8/00; H01M 8/24

(52) U.S. Cl. 429/465; 429/535

(57) ABSTRACT

A contact used to electrically connect High-temperature density fuel cells together is provided. The contact includes at least one hollow cord which each has at least three contact surfaces with the fuel cell, of which two contact surfaces connect neighboring anode surfaces and the third contact surface connects the interconnector of the next High-temperature density fuel cell. A method for producing a fuel cells system including high-power density fuel cells is also provided.

### CROSS REFERENCE TO RELATED APPLICATIONS

This application is the US National Stage of International Application No. PCT/EP2008/062928, filed Sep. 26, 2008 and claims the benefit thereof. The International Application claims the benefits of German application No. 10 2007 046 977.4 DE filed Sep. 28, 2007. All of the applications are incorporated by reference herein in their entirety.

### GOVERNMENT CONTRACT

Development for this invention was supported in part by Contract No. DE-FC26-05NT42613, awarded by the United Stated Department of Energy. Accordingly, the United States Government may have certain rights to this invention.

### FIELD OF INVENTION

The invention relates to a fuel cell system made up of high-temperature fuel cells with solid ceramic electrolytes (SOFC) according to the claims. The invention also relates to a method for production thereof.

### BACKGROUND OF INVENTION

In the earlier patent application WO 2005/117192 A1 fuel cells and systems made up of such fuel cells are described, which make use of what is known as the HPD (High Power Density) principle, wherein a number of tubular cells form a unit, the individual cells being configured specifically as what are known as triangle or delta (Δ) cells. It was found that the power yield with such A cells, in particular with what are known as Δ8 or Δ9 cells, i.e. HPD cells with eight or nine channels, is significantly improved.

These fuel cells pose the problem of connecting the individual HPD elements to one another electrically, the connection also having to be so flexible that the overall arrangement can withstand cyclical loading. Such loading is largely thermal stresses, which are caused by the differing expansion coefficients of the individual components and occur mainly during heating and cooling processes. Generally contacts used for this purpose consist of flat nickel components such as felts or foams, these having a certain elasticity in particular when configured as braided mats.

Flat connections between two fuel cells based on nickel felts are known from the prior art, specific reference being made to the publication “Fuel Cell Systems: Towards Commercialization” in “Power Journal 2001”, pages 10-13.

Elements for use for contacting tubular fuel cells are described in the prepublished documents DE 10 2004 047 761 A1, WO 2006/017777 A2, WO 02/21621 A2 and US 2005/0208363 A1. It is a question here either of forming mat-type elements from knitted metal fabrics, to form the contacts between two fuel cell tubes, or of forming three-dimensional structures that are tailored to the form of the tubular fuel cells from stamped metal sheet or expanded metal. Sufficient elasticity is not guaranteed in the longitudinal direction of the elements, in particular with the latter spatially bent structures. Such structures are not suitable for Δ cells.

### SUMMARY OF INVENTION

Based on the prior art the object of the invention is to simplify and improve electrical contacting for SOFC fuel cell systems.

According to the invention the object is achieved by all the features of the claims. A specific production method for constructing the inventive fuel cell system is the subject matter of the claims. Developments of the invention are set out in the respective subclaims.

The subject matter of the invention is a high-temperature fuel cell system having what are known as HPD fuel cells, with which the individual cells are constructed as what are known as delta (Δ) fuel cells, which are connected to one another as flexible contact arrangement by means of hollow cords, so that each hollow cord has at least three contact surfaces with two adjacent HPD fuel cells respectively. The term “hollow cord” here is a term known in the pertinent art for flexible contact elements respectively enclosing an inner lumen and covers both knitted wire fabrics worked to form round hoses and wire spirals. These embodiments can also particularly advantageously be combined with one another. Such contact elements in the form of hollow cords can have a circular cross section or a basic triangle cross section with rounded corners.

With the invention the electrical contact brought about by the hollow cord ensures uniform axial electrical contacting between the cell anode and what is known as the interconnector of an SOFC fuel cell, with the result that voltage losses due to the ohmic resistance are avoided as far as possible. A sufficient elastic flexibility is also achieved as a further function in this process, so that mechanical loading during the continuous operation of fuel cell systems can largely be compensated for.

It is particularly advantageous that the inventive fuel cell system can absorb vibration during transportation and handling, the specific contacting means providing damping. Also simple non-destructive disassembly is also possible as required, in particular for the purposes of repairing the fuel cell bundles.

The material for the inventive hollow cords consists in the known manner of nickel (Ni) or nickel-based alloys. In some instances copper (Cu) can also be used for the same purpose, if the fuel cells are designed with this in mind, in particular for lower deployment temperatures. Nickel and copper alloys are also possible. It is important that the electrical conductivity is >10⁵ S/m.

### BRIEF DESCRIPTION OF THE DRAWINGS

Further details and advantages of the invention will emerge from the description which follows of figures showing exemplary embodiments in conjunction with the patent claims. The figures show schematic diagrams in which:

FIG. 1 shows a segment from a stack with a number of SOFC HPD fuel cells,

FIG. 2 shows the arrangement from FIG. 1 in a compressed and sintered state,

FIG. 3 shows an enlargement from FIG. 1 clarifying the associated contact points and a first embodiment of the further contact means,

FIG. 4 shows an enlargement from FIG. 2 clarifying the associated contact points and a second embodiment of the further contact means,

FIG. 5 and FIG. 6 show two variants of knitted metal fabrics viewed from above,

FIG. 7 shows the pattern of the current path in HPD fuel cell arrangements from the prior art,

FIGS. 8a and 8b show the pattern of the current path with the new cell connectors,

FIG. 9 shows a cross section of a hollow cord contacting of Δ cells from a knitted fabric with spiral springs above and

FIG. 10 shows a perspective view of the hollow cord contacting according to FIG. 9.

### DETAILED DESCRIPTION OF INVENTION

The figures are described in the same manner as far as possible. Identical parts or parts with identical action have identical or corresponding reference characters.

HPD fuel cells consisting of eight elements are used in each instance below, these being configured respectively as Δ or triangle-shaped, the term Δ8 cell being used to refer to them in the following. However fewer or more individual elements, particularly in the manner of a Δ13 cell are also possible.

The Δ8 cells are produced in a continuous production process by extrusion, press-drawing or the like from the predefined raw materials. Such production methods are known from the prior art, to which end reference is made for example to the publication from “Power Generation” cited above.

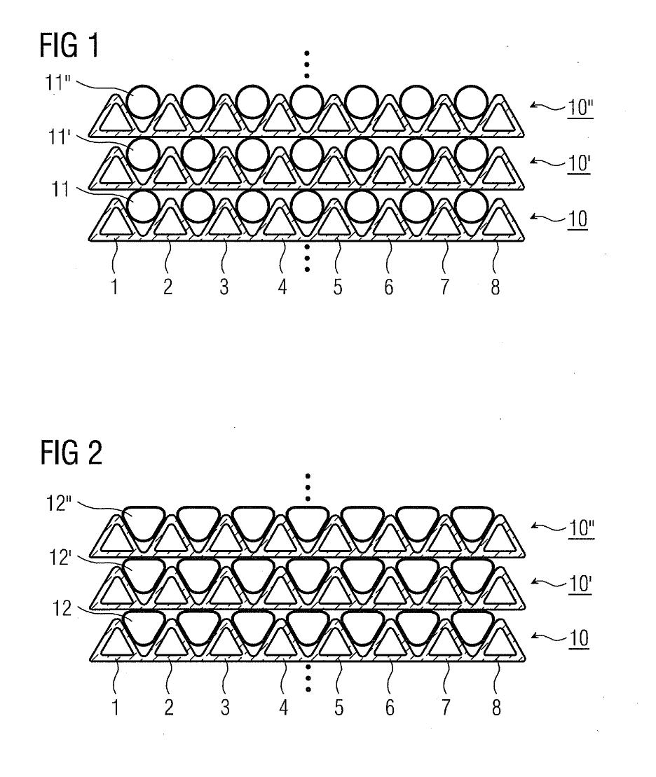

In FIGS. 1 and 2 eight Δ channels 1 to 8 respectively form a fuel cell 10, which is referred to as a delta cell. To construct such cells from a cathode, electrolyte and anode, which are applied as functional layers to a cathodic sintered body, reference should be made to the pertinent prior art. In the prior art, for example according to WO 2005/117192 A1, known delta cells are connected and contacted to form a bundle, for example 3 delta cells 10, 10′ and 10″. The contacting to the cell above is not shown. To function correctly in the complete bundle, the individual delta cells 10, 10′, 10″ must be contacted electrically to one another, to which end additional contact arrangements are used between the anode and the interconnector generally present in SOFC fuel cells. It is also necessary for the electrical contacting including the form-fit connection to be embodied so that mechanical alternating forces or vibrations can be absorbed at changing temperatures during the long-term operation of the fuel cell system.

In FIG. 1 for this purpose individual nickel wires formed into springs are inserted respectively in the manner of hollow cords 11, 11′, 11″, . . . into the Δ forms to serve as electrical contacts. The term “hollow cord” here refers for example to a round hose made of knitted metal wires, having a free inner lumen and a predefined wall thickness, the knitted fabric being manufactured automatically from wires of predefined diameter. However the term also covers wire spirals made of wires of predefined diameter.

It is important with such a hollow cord that on the one hand adequate mechanical characteristics are realized, in particular in respect of elasticity, and on the other hand that good electrical characteristics are ensured. The inner lumen must also be suitable for conveying combustion gas, for which reason a gas-permeable hollow cord wall is advantageous.

FIG. 1 shows the wire structures 11, 11′, . . . arranged over the entire axial length of the HPD cells in the valleys of the Δ channels 1, 2, . . . . To secure the hollow cords 11, 11′, . . . to the associated interconnectors, which are not shown in detail in FIG. 1, nickel or copper-based elements can be used to establish contact. Pastes containing metals are also possible.

For the purposes of practical execution weights are placed on the bundle to establish contact between the nickel wires and the anode or interconnector material, so that a pretension is present during sintering.

The result of this last treatment is shown in FIG. 2. From the round wires or tubes there result arrangements with an essentially triangular base structure with rounded corners, which fit exactly into the Δ channels. Three contact points respectively are formed in this process between the anode surface on the one hand and the interconnector on the other hand.

As well as the circular diameter a triangular cross-sectional geometry is also possible, as shown in FIG. 2 with the hollow cords 12, 12′, . . . . Prior forming can take place here, so that the hollow cords 12, 12′, . . . can be pressed out of shape when the stack is constructed.

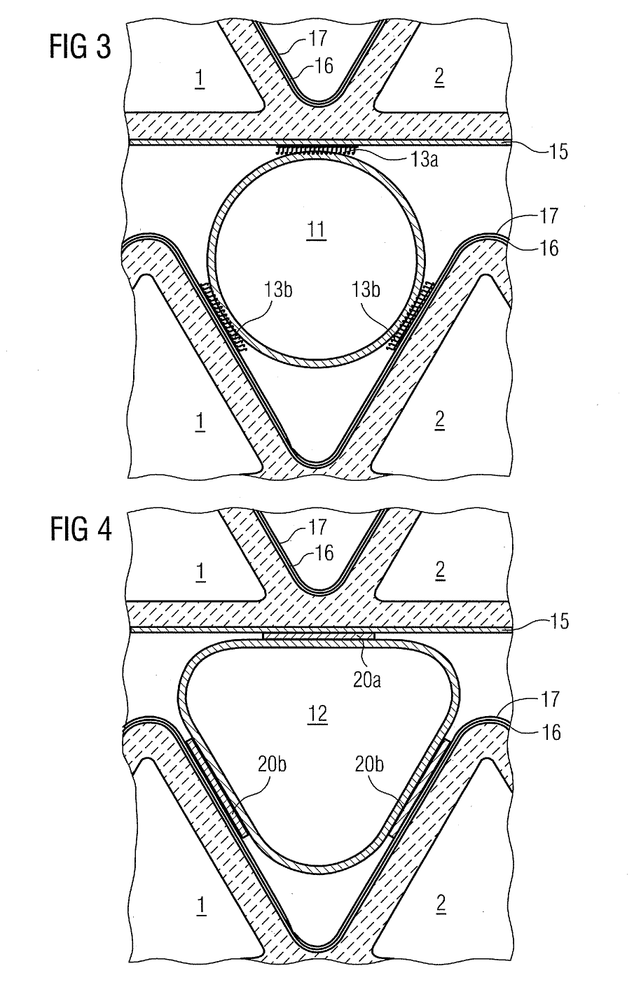

The contacting of the hollow cords 11 and 12 is explained with reference to FIGS. 3 and 4 for an individual Δ cell. It can be seen that in the cross-sectional image according to FIG. 3 the round hollow cord 11 rests against two regions of the sides of the Δ cells 1, 2 in the first layer 10 and against one region on the Δ cell in the next layer 10′, with the interconnector 15 of the next layer 10′ in between. In contrast in the cross-sectional image according to FIG. 4 the triangular hollow cord 11 rests against two strip-type regions of the sides of the Δ cells and against one region on the Δ cell of the next layer 10′.

In FIGS. 3 and 4 conductive epoxy resin can be deployed in the known manner as the elements to establish contact at the contact points between the round nickel cord and the anode surface on the one hand and the interconnector surface on the other hand. The use of metallic adhesive strips, in particular double-sided adhesive nickel tapes, is particularly advantageous, as shown in detail with reference to FIG. 4. Reference should be made in this context to the parallel German patent application by the applicant having identical seniority and the title “Aids for the electrical contacting of high-temperature fuel cells and method for the production thereof”.

FIG. 4 shows the deployment of such adhesive tapes 20a, 20b, 20c for fixing the hollow cord 12 with a triangular cross section. With this hollow cord 12 the surface contacting mentioned above results with the strip-type metal tapes.

Apart from the latter it is also possible to deploy what are known as Velcro tapes 13a, 13b, 13c according to FIG. 3, these having free hooks and a width of 2 to 15 mm for example. Such prefixing also facilitates the production process for industry-compatible mass production of the fuel cells.

The successful application of the invention using double-sided adhesive tape as the connection between the cell connector and the cell has shown that the contact points form solid connections with good electrical contacting after the application of a high temperature. The hollow cords here act as flexible and elastic elements and also as what is known as vibration insulation, as they can absorb mechanical forces.

Resistance measurements taken when the bundle of hollow cords is first heated show that the overall resistance decreases as the temperature rises. A permanent connection is formed between the hollow cord and the cell surface. This fact can be utilized when sintering the bundle when the generator is first heated up (what is known as in situ sintering). It is also possible, by using or deploying the double-sided nickel adhesive tape, to adjust the strength of the sintered connection so that it is possible to take the bundle apart after deployment and after a temperature treatment, without destroying the cell. This fact advantageously allows the bundle to be repaired, which was not possible with arrangements in the prior art.

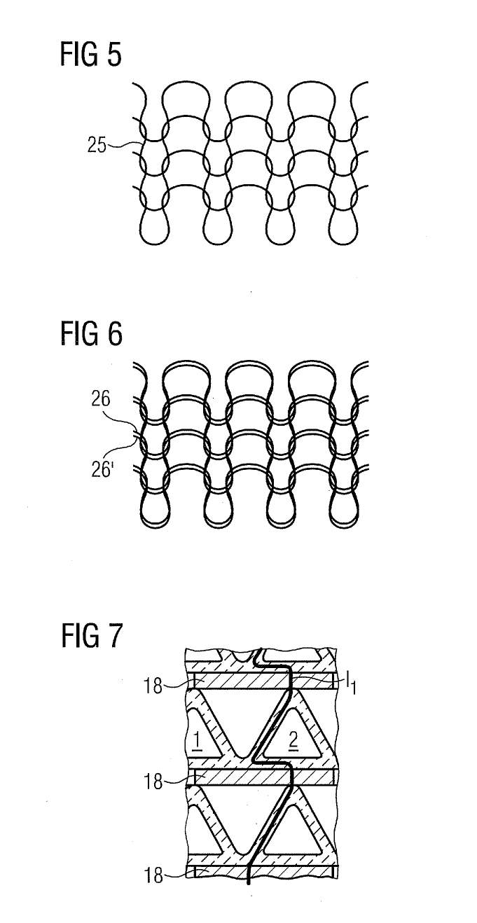

The sectional diagrams in FIGS. 1 to 4 show an individual winding as an individual wire. In practice such arrangements can also be configured from structures according to FIGS. 5 and 6. The hollow cords here are either knitted according to FIG. 5 with one wire 25 or according to FIG. 6 with two wires 26, 26′ in a single layer, two layers or a number of layers to form flexible structures with cross sections in the order of 2 to 50 mm.

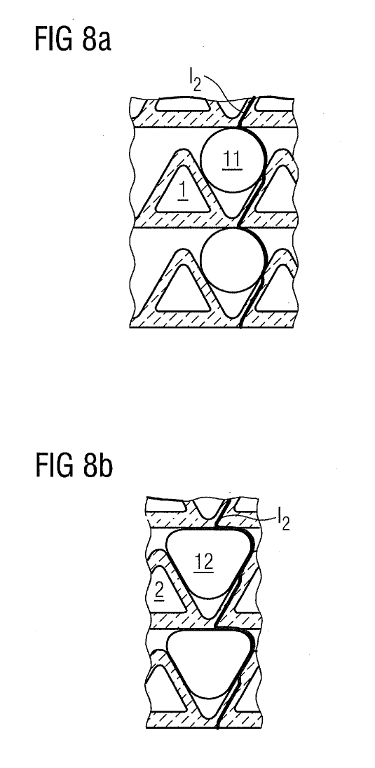

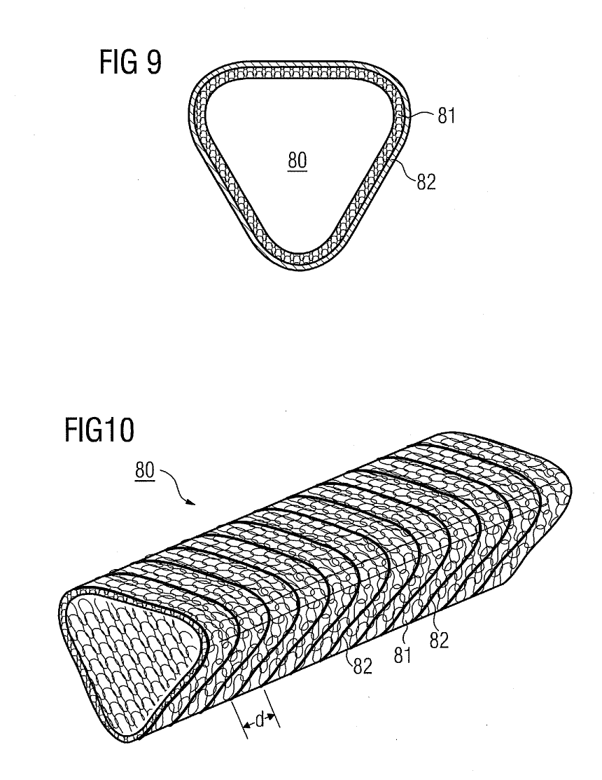

FIGS. 7, 8a and 8b show the current pattern in two HPD fuel cells on top of one another with different contacting. The fuel cells are shown without functional layers here. In so far as according to FIG. 7 a contact element 18 made of a nickel foam material is used in the Δ cell for contacting purposes in the manner known from the prior art, the current I₁ runs in the side of the Δ cell over the entire path and then passes to the next fuel cell by way of the nickel foam 17.

In the examples in FIGS. 8a and 8b hollow cords with alternately round and triangular cross sections are used as contacts. In contrast to FIG. 7 the current I₂ therefore runs from the first Δ cell without the contact element by way of a part of the metallic hollow cord directly to the next Δ cell, with the result that the overall electrical resistance of such arrangements is considerably reduced.

It can also be seen from the two partial FIGS. 8a and 8b that when hollow cords according to the invention are used, the current path for I₂ in the anode surface of an individual Δ cell is shorter than the current path for I₁. As mentioned above, the current I₂ is taken directly from the hollow cord and conducted from there to the interconnector of the next fuel cell layer. When configuring the round hose structure with triangular cross section essentially the same situation applies, with a larger region of anode surface with a contacting layer positioned on it resulting here.

FIG. 9 shows a section through such a hollow cord arrangement 80, which on the one hand has an essentially triangular cross section and on the other hand consists of two separate hollow cord layers 81, 82 joined together with a form fit. The inner layer 81 is formed by a knitted wire fabric hose in the manner of the first hollow cord according to the configurations described above and ensures the provision of the elasticity required for correct use. A wire loop or spiral 82 is applied to this knitted wire fabric hollow cord 81 in the manner of an outer layer, also realizing a hollow cord as a continuous spiral per se—as defined in detail above. This outer hollow cord 82 with compact wire surfaces ensures that electrical requirements are satisfied in this process.

FIG. 10 shows a perspective view of the hollow cord arrangement 80 from FIG. 9. Here a hose-type knitted fabric is enclosed by a spiral-type winding. In FIG. 10 an interval (spacing of the spiral) of around ten times the wire diameter of the knitted fabric results, for example around d=1 mm. The interval can also be up to around 10 mm. This interval minimizes nickel consumption while still ensuring adequate contacting with the fuel cell.

Electrical measurements taken on differently configured arrangements according to FIGS. 1, 2 and 8 as well as 9, 10 showed significant improvements in contacting and in particular a lower voltage loss value, a specific conductivity of 11.5*10⁶ S/m being assumed for nickel and 57*10⁶ S/m for copper. It is thus possible for the HPD fuel cells with Δ structure, which have proven advantageous in practice, to be combined in an improved manner to form a bundle of a complete fuel cell arrangement.

1-25. (canceled)

26. A fuel cell system, comprising:
a plurality of high-temperature fuel cells with solid ceramic electrolytes, the individual fuel cells, comprising:
a plurality of hollow structures configured as triangular and being connected solidly, the plurality of hollow structures are connected to one another by flexible contact arrangements; and
a hollow cord,
wherein the flexible contact arrangements in each instance include the hollow cord, and
wherein the hollow cord includes at least three contact surfaces with adjacent high temperature fuel cells.

27. The fuel cell system as claimed in claim 26, wherein the hollow cord comprises a knitted wire fabric including an inner lumen.

28. The fuel cell system as claimed in claim 26, wherein the hollow cord comprises a wire spiral.

29. The fuel cell system as claimed in claim 26,
wherein the hollow cord comprises an inner layer with the knitted wire fabric and an inner lumen, and
wherein the hollow cord comprises an outer layer with a wire spiral in a form of a loop.

30. The fuel cell system as claimed in claim 26, wherein the hollow cord has a round cross section.

31. The fuel cell system as claimed in claim 26, wherein the hollow cord has a triangular cross section with rounded corners.

32. The fuel cell system as claimed in 31, wherein a plurality of elements used to establish contact are disposed on the plurality of high-temperature fuel cells between the wire spiral and the contact surfaces.

33. The fuel cell system as claimed in claim 32, wherein the plurality of elements to establish contact are metal structures in a form of a Velcro fastening.

34. The fuel cell system as claimed in claim 32, wherein the plurality of elements to establish contact are a conductive double-sided adhesive tape including a metal base.

35. The fuel cell system as claimed in claim 26, wherein the hollow cord comprises knitted wire fabric in the form of a hose.

36. The fuel cell system as claimed in claim 27, wherein the knitted wire fabric is knitted from a single wire.

37. The fuel cell system as claimed in claim 27, wherein the knitted wire fabric is knitted from two parallel wires or a plurality of wires.

38. The fuel cell system as claimed in claim 36, wherein the hollow cord comprises a single layer knitted wire fabric.

39. The fuel cell system as claimed in claim 37, wherein the hollow cord comprises two layer or multilayer knitted wire fabrics.

40. The fuel cell system as claimed in claim 37, wherein that the electrical conductivity of the hollow cord knitted wire fabrics is >10⁵ S/m.

41. The fuel cell system as claimed in claim 27, wherein a material for the hollow cord knitted wire fabric is nickel, copper, or alloys of nickel and/or copper.

42. A method for producing a fuel cell system including high-temperature fuel cells with solid ceramic electrolytes, comprising:
constructing the individual fuel cells from a plurality of triangular hollow structures and connected solidly;
connecting the plurality of hollow structures to one another by flexible contact arrangements; and
placing a plurality of hollow cords against a plurality of contact surfaces of individual fuel cells and forming the plurality of individual fuel cells and hollow cords into a fuel cell bundle,
wherein in situ sintering takes place when individual fuel cell bundles are constructed.

43. The production method as claimed in claim 42, wherein that after the construction, a non-destructive disassembly takes place for repair purposes, as required, in the individual fuel cell bundles.

44. The production method as claimed in claim 42,
wherein the plurality of hollow cords comprise metallic knitted wire fabrics, and
wherein the plurality of hollow cords have an electrical conductivity of >10⁵ S/m.

45. The production method as claimed in claim 42, wherein nickel, copper, or alloys of nickel and/or copper are used as a material for the hollow cord knitted wire fabric.
